(19) United States
(12) Patent Application Publication
(10) Pub. No.: US 2020/0317127 A1
(43) Pub. Date: Oct. 8, 2020

(54) METHOD AND APPARATUS FOR ARTICULATING MIRRORS FOR TRAILERING IN A MOTOR VEHICLE

(71) Applicant: GM GLOBAL TECHNOLOGY OPERATIONS LLC, Detroit, MI (US)

(72) Inventor: Jeremy K. Archer, Howell, MI (US)

(73) Assignee: GM GLOBAL TECHNOLOGY OPERATIONS LLC, Detroit, MI (US)

(21) Appl. No.: 16/373,828

(22) Filed: Apr. 3, 2019

(51) Int. Cl. B60R 1/07; B60R 11/04; G01S 17/06; G01S 13/06; G06K 9/00

(52) U.S. Cl. CPC B60R 1/07; B60R 11/04; B60Y 2200/147; G01S 13/06; G06K 9/00791; G01S 17/06

(57) ABSTRACT

Methods and apparatus are provided for articulating mirrors for trailering in a motor vehicle. The apparatus includes a detector for detecting a trailer component, a mirror positioner for positioning a mirror in response to a control signal, and a processor determining a trailer angle in response to the trailer component and for generating the control signal in response to the trailer angle.

The present disclosure relates generally to a system of articulating trailer mirrors for use in a trailering application with a motor vehicle. More specifically, aspects of the present disclosure relate to systems, methods and devices for monitoring a trailer position when operating a vehicle with attached trailer and for automatically articulating the vehicle mirrors such that the trailer remains visible within the mirror.

Pulling a trailer with a tow vehicle has always been and remains a complicated endeavor for many drivers. The ball hitch is typically employed as a trailer connection and provides a joint between the tow vehicle and the trailer. Aiming the trailer involves turning the rear of the tow vehicle in the opposite direction of the desired direction of the trailer. While the trailer movement is happening behind the tow vehicle, the driver must monitor the operation through the vehicle mirrors. As the trailer turns, the centerline of the trailer moves farther away from the centerline of the towing vehicle. When this happens, the driver can no longer see the rear of the trailer from the tow vehicle mirrors. Typically, a driver must rely on a second person to provides instructions to continue backing up, stop the tow vehicle and manually adjust the mirrors, or move the driver's head or body position to get a better view of the rear of the trailer. It would be desirable to provide a better trailer reversing option while overcoming the aforementioned problems.

The above information disclosed in this background section is only for enhancement of understanding of the background of the invention and therefore it may contain information that does not form the prior art that is already known in this country to a person of ordinary skill in the art.

### SUMMARY

Disclosed herein are vehicle braking methods and systems and related control logic for provisioning vehicle systems, methods for making and methods for operating such systems, and motor vehicles equipped with onboard control systems. By way of example, and not limitation, there is presented various embodiments of an automatically articulating mirror system for trailering in a motor vehicle, and a method for performing automatically articulating mirror system for trailering in a motor vehicle are disclosed herein.

In accordance with an aspect of the present invention an apparatus having a detector for detecting a trailer component, a mirror positioner for positioning a mirror in response to a control signal, and a processor determining a trailer angle in response to the trailer component and for generating the control signal in response to the trailer angle.

In accordance with another aspect of the present invention wherein the detector is a camera and the trailer component is determined in response to an image captured by camera.

In accordance with another aspect of the present invention wherein the detector is a camera and the trailer component is detected using image recognition.

In accordance with another aspect of the present invention wherein the mirror positioner is operative to position the mirror such that the trailer component is visible in the mirror by a driver.

In accordance with another aspect of the present invention wherein the detector is mounted proximate to the mirror.

In accordance with another aspect of the present invention wherein the detector is operative to determine an electrical connection to a trailer and wherein the trailer component is detected in response to the determination of the electrical connection.

In accordance with another aspect of the present invention wherein the detector includes a lidar system.

In accordance with another aspect of the present invention wherein the detector includes a radar system.

In accordance with another aspect of the present invention a method for capturing an image of a trailer component, estimating a location of the trailer component in response to the image, estimating a trailer angle in response to the location of the trailer component, and generating a control signal in response to the trailer angle, and adjusting a mirror in response to the control signal.

In accordance with another aspect of the present invention wherein the mirror is adjusted such that the trailer component is visible within the mirror to a vehicle operator.

In accordance with another aspect of the present invention wherein the image is generated by a lidar system.

In accordance with another aspect of the present invention wherein the image is generated by a radar system,

In accordance with another aspect of the present invention wherein the image is captured in response to an indication of a reverse operation during a towing operation.

In accordance with another aspect of the present invention wherein the image is captured by a rear view camera.

In accordance with another aspect of the present invention wherein the method is performed by a vehicle controller in response to an indication of a towing operation.

In accordance with another aspect of the present invention wherein the method is performed by a vehicle controller in response to an indication of a reversing of a vehicle.

In accordance with another aspect of the present invention a vehicular mirror control system having an input for receiving an image from a vehicle camera, a controller for controlling a mirror position and a processor for detecting a trailer component within the image, for estimating a trailer angle in response to the detection of the trailer component within the image, and for generating the mirror control signal to position a mirror in response to the trailer angle such that the trailer component is visible to a driver through the mirror.

In accordance with another aspect of the present invention wherein the vehicle camera is mounted to the side of a vehicle.

In accordance with another aspect of the present invention wherein the image is received in response to an indication of a towing condition.

In accordance with another aspect of the present invention wherein the image is received in response to a requested by the processor and wherein the request is generated in response to an indication from a vehicle controller of a reverse condition.

### BRIEF DESCRIPTION OF THE DRAWINGS

The exemplary embodiments will hereinafter be described in conjunction with the following drawing figures, wherein like numerals denote like elements, and wherein:

FIG. 1 shows an application for the method and apparatus for articulating mirrors for trailering in a motor vehicle according to an exemplary embodiment of the present disclosure.

FIG. 2 shows a block diagram illustrating a system for articulating mirrors for trailering in a motor vehicle according to an exemplary embodiment of the present disclosure; and

FIG. 3 shows a flow chart illustrating a method for articulating mirrors for trailering in a motor vehicle according to an exemplary embodiment of the present disclosure.

FIG. 4 shows a block diagram illustrating a system for articulating mirrors for trailering in a motor vehicle according to another exemplary embodiment of the present disclosure; and

FIG. 5 shows a flow chart illustrating a method for articulating mirrors for trailering in a motor vehicle according to another exemplary embodiment of the present disclosure.

The exemplifications set out herein illustrate preferred embodiments of the invention, and such exemplifications are not to be construed as limiting the scope of the invention in any manner.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

The present application discloses a system of outside rearview mirrors which automatically move in response to the position of an attached trailer. The mirrors automatically adjust to maintain visibility of portions the trailer in a common area of the mirror. The method and system teach that the side mirrors are linked to a system to detect the position and orientation of an attached trailer and determine the necessary mirror adjustment to maintain visibility and to automatically adjust the mirrors in response to the detection. In an exemplary embodiment, the towing vehicle's power mirrors automatically adjust to show trailer tires in a common mirror location as the trailer articulates relative to the towing vehicle. The driver mirror is active when the trailer is articulated to the left and the passenger mirror when the trailer is articulated to the right. The system may be operative in both reversing the tow vehicle with an attached trailer, or driving forward with the tow vehicle for monitoring trailer position during turns, such as around corners and lane positioning.

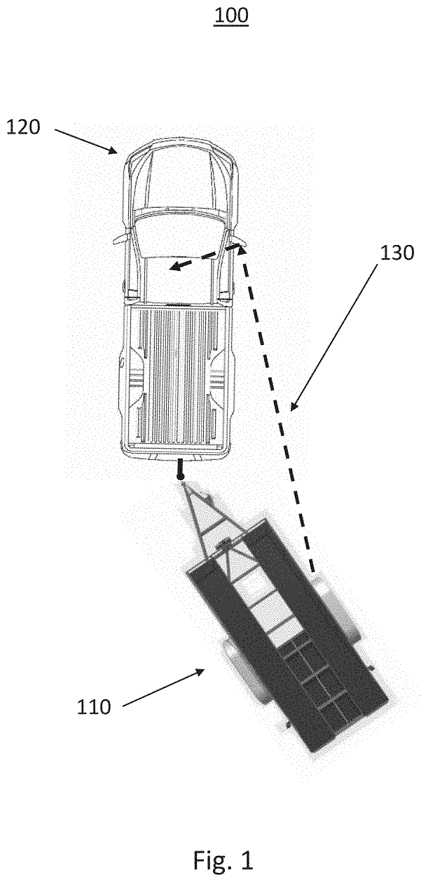

Turning now to FIG. 1, an application for the method and apparatus for articulating mirrors for trailering in a motor vehicle 100 according to an exemplary embodiment of the present disclosure is shown. The exemplary application shows a towing vehicle 120 and a trailer 110. The line of sight 130 of the driver using the passenger side mirror is also illustrated. According to the exemplary embodiment, the passenger side mirror has been adjusted such that the trailer wheels are within the line of sight 130. If the mirrors were not adjusted, the driver's line of sight would be along the passenger side of the towing vehicle towards the rear, and the mirror would show the front corner of the trailer 110.

This system is operative to enhance conventional power side mirrors with the algorithm and control to automatically maintain the image of the trailer in the mirrors utilizing existing mirror and trailer sensing systems. Current systems using cameras and video displays lack the automatic tracking and adjustment to maintain the image as the trailer moves.

According to an exemplary embodiment, the method and system are operative to determine the movement of the mirror to maintain the image of the trailer for the driver in a common area on the mirror surface. The system determines the necessary adjustment of the outside rearview mirrors to maintain trailer visibility by employs the geometry of the vehicle and trailer and algorithm to calculate the displacement of the mirror. The system may use data from a positioning system that detects the position and orientation of an attached trailer using sensors, cameras and a trailer detection module. Existing vehicle hardware is leveraged including power side rear-view mirror system and the trailer detection system such that the disclosed algorithm may be implemented to control the mirror movement to the rear-view mirror system and via the vehicle bus.

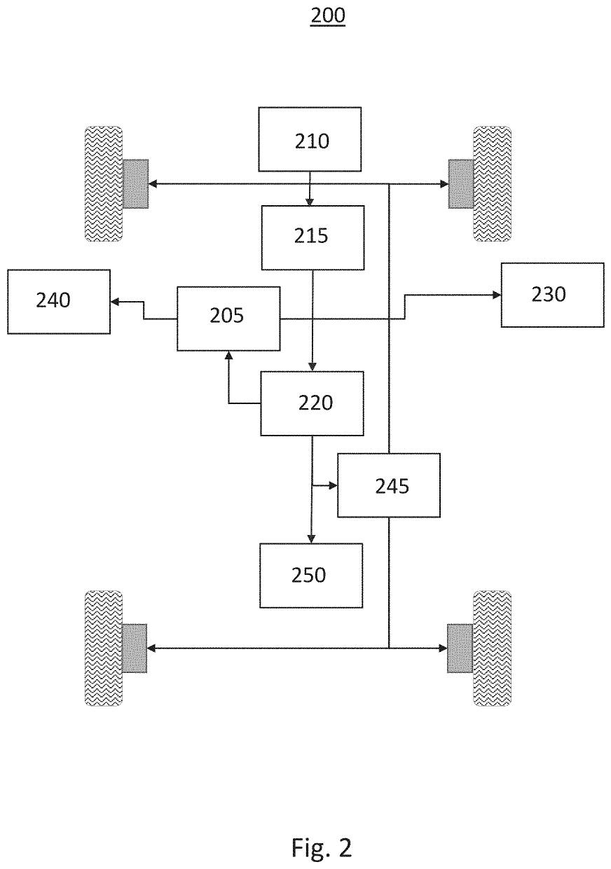

Turning now to FIG. 2, a block diagram of an exemplary system for articulating mirrors for trailering in a motor vehicle 200 according to an exemplary embodiment of the present disclosure is shown. The system 200 includes a driver's side mirror 240, a passenger side mirror 230, a processor 220, a vehicle controller 245, a trailer interface module 250, a camera 210, and a mirror control system 205.

The mirror control system 205 is operative to receive control signals from a user interface to adjust the angles of the driver's side mirror 240 and the passenger side mirror 230. These control signals are typically generated in response to a driver input as the driver sits in the driver's seat and adjusts the angle of the mirrors for the desired rear view. Motors in the housing of the driver's side mirror 240 and the housing of the passenger side mirror 230 are operative to angle their respective mirrors in both horizontal and vertical directions in response to the control signals.

In this exemplary embodiment, the trailer interface module 250 may be operative to control the lighting and breaking of a trailer in response to control signals from the vehicle controller 245 and the processor 220. The trailer interface module 250 may also be operative to generate an indication of an attached trailer. This may be done in response to an impedance measurement on the trailer electrical connector, a deflection measurement on the trailer hitch, or in response to the vehicle being placed into a towing mode.

The camera 210 may be a wide angle aspect camera mounted to the rear of the vehicle such that the sides of a trailer could be seen during reverse towing operations. Alternatively, or in addition, the camera 210 could be one of a plurality of cameras mounted on each side view mirror. The camera 210 may then have a wide angle view from the side mirror viewpoint. The camera 210 may transmit an image or series of images to the processor 220 or to a video controller 215 for processing the images and coupling this signal to the processor 220.

The processor 220 is operative to control the method for articulating mirrors for trailering in a motor vehicle. The processor 220 may receive data from the trailer interface module 250, the vehicle controller 245, the camera 210 and/or the video processor 215. The processor 220 may operative to receive vehicle information, such as wheelbase and driver position and trailer information, such as trailer wheelbase, trailer dimensions, trailer track, trailer articulation angle, etc.

In an exemplary embodiment, the processor 220 is operative to monitor the steering position and the longitudinal velocity of the vehicle through the vehicle controller 245. The system is further operative to monitor the trailer interface module 250 to determine if a trailer is being towed. If the trailer is being towed and the vehicle velocity indicates a rearward motion, the processor 220 is operative to estimate the trailer angle in response to the trailer dimensions, the steering and velocity and to generate a mirror control signal to couple to the mirror control system 205. The mirror control system 205 is operative to adjust the appropriate mirror, either passenger side mirror 230 or driver's side mirror 240, in response to the mirror control signal. The mirror control system 205 may estimate mirror articulation geometry based on a control algorithm or the like.

In another exemplary embodiment, the processor 220 is operative to use image recognition techniques in order to determine the angle of a towed trailer. For example, if the trailer interface module 250 indicates that a trailer is being towed and the vehicle controller 245 indicates that the vehicle is traveling in a rearward direction, the processor 220 is operative to receive an image from the video controller 215 of the trailer. The processor 220 may estimate the location of the tires of the trailer or may use edge detection techniques to determine the rear back edge of the trailer. Once the processor 220 determines the location or the tires, or rear edge, the processor then estimates the location and orientation of the trailer and then generates a mirror control signal to couple to the mirror control system 205. The mirror control system 205 is then operative to adjust the appropriate mirror, either passenger side mirror 230 or driver's side mirror 240, in response to the mirror control signal. In an alternative embodiment, the image processing may be performed by the video processor 215.

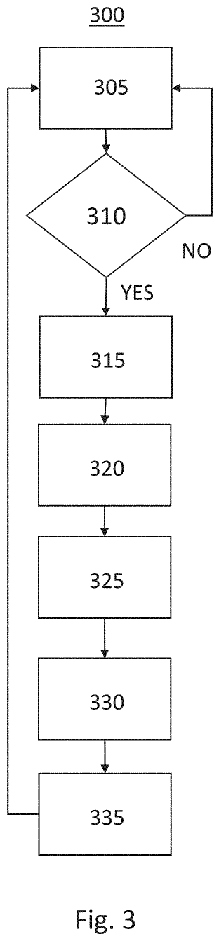

Turning now to FIG. 3, a flow chart illustrating an exemplary method for articulating mirrors for trailering in a motor vehicle 300 according to an exemplary embodiment of the present disclosure is shown. In this exemplary embodiment the method is first operative to receive an indication of a towing operation 305. Examples of this indication may include the towing vehicle being placed into a tow mode via a user interface, an indicator from a trailer interface module indicating the connection of a trailer, or a change in voltage or capacitance on a trailer electrical connector indicating a trailer electrical system has been connected. The user interface may include a button within the vehicle compartment or may be selected through an option on a visual user interface on an infotainment system. The trailer interface module may determine the presence of a trailer in response to an electrical connector being connected or through a deflection of a trailer hitch or in response to a longitudinal force on the trailer hitch.

In response to the indication of a towing operation, the method is then operative to determine if a reverse towing operation is occurring 310. The reverse operation may be determined in response to a transmission gear indicator indicative of the transmission being placed in reverse. The reverse towing operation may be determined in response to a rearward velocity measured by a vehicle controller, or may be determined in response to a longitudinal force on the hitch mechanism.

In this exemplary embodiment, once the reverse towing operation has been determined, the method is then operative to receive an image from a rear facing camera 315. The rear facing camera may be a wide angle camera mounted on the rear of the vehicle or may be a camera mounted onto a side view mirror of the vehicle. The image may be a single image or a frame of a video stream. The image may be a composite rear view image generated by combining, or stitching, an image take from a driver's side mirror camera and an image taken from a passenger side mirror camera. This composite image may simultaneously display both sides of the trailer.

The method is then operative to determine the location of an indicative component of the trailer in the image 320, such as the wheels, a front corner, or a back corner of the trailer. Image recognition techniques may be applied by a video processor or the like to locate objects in the image. Image recognition techniques may include an image classifier algorithm for detecting a component of the trailer such as the wheels. Additional image recognition techniques may include edge detection, shape detection, and convolutional neural networks.

The method may then be operative to estimate a trailer angle 325 by comparing an angle of the centerline of the trailer with respect to an angle of the centerline of the towing vehicle. The physical dimension of the trailer may be determined in response to a user input, wherein a user may enter the physical dimensions directly into a user input, or may select a general size and share of a trailer, such as a small utility trailer, flatbed car trailer or a fifth wheel camper trailer. In response to the detected indicative component of the trailer, the method then estimates the deviation between the centerline of the trailer and the centerline of the tow vehicle. This estimation may use standard geometrical computations or may be determined in response to camera positioning and location information within the image.

The method is then operative to generate a control signal 330 to adjust the mirror in response to the trailer angle, driver position, and dimensions of the trailer. Additional factors for generating the control signal may be velocity and/or angle of steering of the towing vehicle. In an exemplary embodiment, the method may be operative to determine the current angle of the mirror as a baseline for the driver view. A control signal may then be generated to adjust the mirror from the baseline an amount that would compensate for the deviation of the trailer. For example, if the deviation between the centerline of the trailer and the centerline of the tow vehicle is 45 degrees to the passenger side, it may be determined that the passenger side mirror must angle out 7 additional degrees in order for the driver to see the trailer wheels and/or trailing edge. The control signal is then indicative of a 7 degree adjustment from the current baseline position. The control signal may then be coupled to a mirror control system or directly to the appropriate mirror for adjustment in response to the control signal 335.

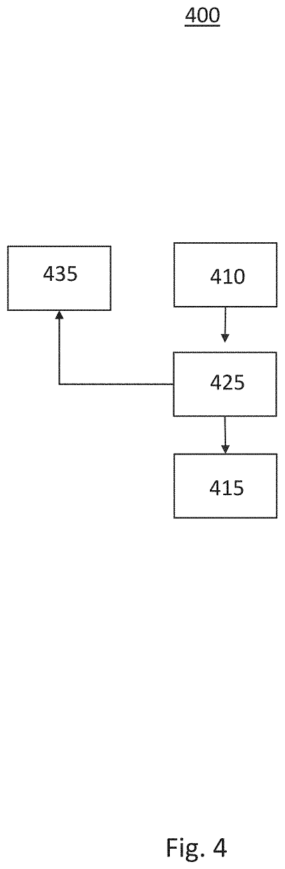

Turning now to FIG. 4, a block diagram of a system for articulating mirrors for trailering in a motor vehicle 400 according to an exemplary embodiment of the present disclosure is shown. A vehicular mirror control system includes a detector 410, a mirror controller 415, a vehicle controller 435 and a processor 425.

The detector 410 is operative to generate an image of a trailer wherein the image includes a particular trailer component of interest, such as a leading edge, a trailing edge, and/or a wheel. The detector 410 may be any system operative to capture or generate an image of a field of view around a vehicle such as a camera, a lidar system, a radar system or the like. The detector 410 may be operative to capture the image in response to a request signal from the processor 425. Alternatively, the detector 410 may employ ultrawideband sensor technology for monitoring trailer position through transmitters located on the trailer. The detector may also use a mechanical angle sensor mounted between the trailer and the tow vehicle.

The processor 425 is operative to first determine a reverse towing operation. A reverse towing operation may be defined as an operation wherein a towing vehicle is traveling in a reverse or rearward direction while towing a trailer such that the towing vehicle is pushing the trailer in a reverse direction. The processor 425 may determine this reverse operation in response to an indication by a vehicle controller 435 that the vehicle transmission has been placed in reverse. Alternatively, the processor 425 may determine this reverse operation in response to a velocity indication by the vehicle controller 435 or other vehicle sensor that the vehicle is moving in reverse.

The processor 425 is then operative to request an image from the detector 410. The processor 424 using image processing techniques, or the like, is operative to detect a trailer component within the image. In this exemplary embodiment, the component may be wheel of the trailer. The processor 425 then estimates a trailer angle in response to the detection of the trailer component within the image. This estimation may be performed in response to a saved geometry of the trailer and/or towing vehicle. The processor 425 is then operative to generate a mirror control signal to position a mirror in response to the trailer angle such that the trailer component is visible to a driver through a mirror. The mirror may be mounted to the side of a vehicle. The mirror control signal may also be generated in response to a driver's seat position, the trailer dimensions, the steering angle and/or the vehicle velocity.

The mirror control signal is then coupled to a mirror controller 415. The mirror controller 415 is operative to determine a mirror to be adjusted in response to the mirror control signal. The mirror controller may further be operative to determine a first mirror angle when a vehicle is operated in a forward towing condition. The mirror is then operative to position the mirror in response to the mirror control signal using the first mirror angle as a reference angle. In this exemplary embodiment, the mirror is adjusted such that a reflection of the trailer component is visible in the mirror to a driver of the vehicle.

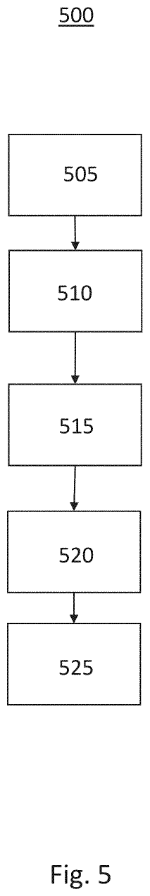

Turning now to FIG. 5, a flow chart illustrating another exemplary method for articulating mirrors for trailering in a motor vehicle 500 according to an exemplary embodiment of the present disclosure is shown. The method is first operative to capture an image of a trailer component 505. The image may be captured by a rear facing camera or by a plurality of cameras such that the image is a composite image having a field of view towards a trailer at the rear of a vehicle. The method then estimates a location of the trailer component 510 in response to the image. The estimation may be made in response to a location of the trailer component within the image. The method then estimates a trailer angle in response to the location of the trailer component 515. The trailer angle is measured as the angle between a trailer centerline and a vehicle centerline. For example, in forward towing operations for a vehicle traveling in a straight line, the trailer angle would be zero degrees. However, during a turn the trailer angle would increase in response to an increase in the rate of the turn.

After determining the trailer angle, the method is then operative to generate a control signal in response to the trailer angle 520. The control signal may be indicative of the trailer angle or on how much the mirror should be adjusted. For example, the processor may consider the vehicle dimensions, the trailer dimensions and the trailer angle to determine that the trailer component has moved outside of a visible range of the mirror and that the mirror should be adjusted a number of degrees to bring the trailer component back into view. The method is then operative to adjust the mirror in response to the control signal 525. Thus, the mirror is adjusted such that the trailer component is visible within the mirror to a vehicle operator.

In this exemplary embodiment, the method may be performed by a vehicle controller in response to an indication of a reversing of a vehicle. The image may be generated by a lidar system or a radar system or captured by a rear view camera. The image may be captured in response to an indication of a reverse operation during a towing operation.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. An apparatus comprising:
a detector for detecting a trailer component;
a mirror positioner for positioning a mirror in response to a control signal; and
a processor determining a trailer angle in response to the trailer component and for generating the control signal in response to the trailer angle.

2. The apparatus of claim 1 wherein the detector is a camera and the trailer component is determined in response to an image captured by camera.

3. The apparatus of claim 1 wherein the detector is a camera and the trailer component is detected using image recognition.

4. The apparatus of claim 1 wherein the mirror positioner is operative to position the mirror such that the trailer component is visible in the mirror by a driver.

5. The apparatus of claim 1 wherein the detector is mounted proximate to the mirror.

6. The apparatus of claim 1 wherein the detector is operative to determine an electrical connection to a trailer and wherein the trailer component is detected in response to the determination of the electrical connection.

7. The apparatus of claim 1 wherein the detector includes a lidar system.

8. The apparatus of claim 1 wherein the detector includes a radar system.

9. A method comprising:
capturing an image of a trailer component;
estimating a location of the trailer component in response to the image;
estimating a trailer angle in response to the location of the trailer component;
generating a control signal in response to the trailer angle; and
adjusting a mirror in response to the control signal.

10. The method of claim 9 wherein the mirror is adjusted such that the trailer component is visible within the mirror to a vehicle operator.

11. The method of claim 9 wherein the image is generated by a lidar system.

12. The method of claim 9 wherein the image is generated by a radar system,

13. The method of claim 9 wherein the image is captured in response to an indication of a reverse operation during a towing operation.

14. The method of claim 9 wherein the image is captured by a rear view camera.

15. The method of claim 9 wherein the method is performed by a vehicle controller in response to an indication of a towing operation.

16. The method of claim 9 wherein the method is performed by a vehicle controller in response to an indication of a reversing of a vehicle.

17. A vehicular mirror control system comprising;
an receiver configured to receive an image from a vehicle camera;
a controller configured to a mirror position in response to a mirror control signal;
a processor configured to detect a trailer component within the image, estimate a trailer angle in response to the detection of the trailer component within the image, generate the mirror control signal to position a mirror in response to the trailer angle such that the trailer component is visible to a driver through the mirror, estimate a trailer angle in response to the location of the trailer component, and generate a control signal in response to the trailer angle.

18. The vehicular mirror control system of claim 17 wherein the vehicle camera is mounted to the side of a vehicle.

19. The vehicular mirror control system of claim 17 wherein the image is received in response to an indication of a towing condition.

20. The vehicular mirror control system of claim 17 wherein the image is received in response to a requested by the processor and wherein the request is generated in response to an indication from a vehicle controller of a reverse condition.
